(19) United States
(12) Patent Application Publication
(10) Pub. No.: US 2024/0320577 A1
(43) Pub. Date: Sep. 26, 2024

(54) Automated Batch Sizing of Background Jobs

(71) Applicant: SAP SE, Walldorf (DE)

(72) Inventors: Torsten Krause, Wiesloch (DE); Ralf Missal, Lampertheim (DE); Oleg Loewen, Mannheim (DE)

(21) Appl. No.: 18/123,515

(22) Filed: Mar. 20, 2023

(51) Int. Cl. G06Q 10/0631

(52) U.S. Cl. CPC G06Q 10/06312

(57) ABSTRACT

A method, a system, and computer program product for automated batch sizing for optimizing background jobs based on background job history data. A background job type of a background job scheduled to be executed, as a plurality of batches, by a plurality of servers, is identified. Background job history data for the background job type is retrieved. A batch size of the plurality of batches for an execution of the background job is determined using the background job history data corresponding to the background job type. The batch size of the plurality of batches is optimized based on one or more background job characteristics. An execution of the background job by the plurality of servers is controlled.

### TECHNICAL FIELD

The disclosed subject matter generally relates to background job processing optimization and more particularly to automated batch sizing of background jobs.

### BACKGROUND

Daily activities of analytic systems serving multiple customers consume an increasing amount of processing resources of a shared multithreaded server. Data activities include multiple background jobs. Each background job can be triggered daily at a particular time. For example, the timesheets of all the employees of an entity are processed daily. For some background jobs, the execution of the background job on a large data set would utilize too many resources that would lead to crowding out other background jobs from other users and sometimes system failures where the background job would either not get completed on time or completed with errors. A previous optimization technique manually separated the data (e.g., hundreds of thousands of timesheets) into multiple sequentially run jobs (e.g., for hundreds or thousands of timesheets), a part of which can be executed in parallel by the available server threads of the shared multithreaded server. The results of all packages have impact on server memory until job completion. The size of the package on job level was determined by fixed, simple division (e.g. due to the available resource, the processing of 100,000 timesheets must be distributed to 50 job runs, so each job processes 2,000 timesheets) and was estimated by a human user only after resource constraints or execution failures occurred. Once set by an administrator, the package size remained constant until the next failure occurred. Despite this manual optimization, situations arose where the resources of the multithreaded server can still be exhausted, the job is aborted, and the data is incompletely processed.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with some implementations of the disclosed subject matter, manufactured articles, devices, systems and methods are provided for automated batch sizing for optimizing execution of long running background jobs. In one aspect there is provided a computer-implemented method including: identifying, by one or more processors, a background job type of a background job scheduled to be executed, as a plurality of batches, by a plurality of servers, retrieving, by the one or more processors, background job history data for the background job type, determining, by the one or more processors, using the background job history data corresponding to the background job type, a batch size of the plurality of batches for an execution of the background job, optimizing, by the one or more processors, the batch size of the plurality of batches based on one or more background job characteristics, and controlling, by the one or more processors, an execution of the background job by the plurality of servers.

Implementations may include one or more of the following features. In some variations, the computer-implemented method may include: identifying, by the one or more processors, that the background job history data may include a critical background job; and adjusting, by the one or more processors, the batch size based on the critical background job. In some variations, the computer-implemented method may include: providing, by the one or more processors, the batch size, to a database, for storage. In some variations, the one or more background job characteristics may include a maximum duration of the execution of the background job. Determining, by the one or more processors, the batch size of the plurality of batches is based on a set batch size limit and a set number of batches. In some variations, the background job may include entity identifiers of a set of data items associated to a plurality of entities. In some variations, the computer-implemented method may include: generating, by the one or more processors, from the set of data items, a reduced set of data items corresponding to the batch size, the reduced set of data items being scheduled to be processed during the execution of the background job.

In another aspect, there is provided a non-transitory computer-readable storage medium including programming code, which when executed by at least one data processor, causes operations including: identifying a background job type of a background job scheduled to be executed, as a plurality of batches, by a plurality of servers, retrieving background job history data for the background job type, determining using the background job history data corresponding to the background job type, a batch size of the plurality of batches for an execution of the background job, optimizing the batch size of the plurality of batches based on one or more background job characteristics, and controlling an execution of the background job by the plurality of servers.

Implementations may include one or more of the following features. The operations may include: identifying that the background job history data may include a critical background job; and adjusting the batch size based on the critical background job. The operations may include: providing the batch size, to a database, for storage. The one or more background job characteristics may include a maximum duration of the execution of the background job. Determining the batch size of the plurality of batches is based on a set batch size limit and a set number of batches. The background job may include entity identifiers of a set of data items associated to a plurality of entities. The operations may include: generating from the set of data items, a reduced set of data items corresponding to the batch size, the reduced set of data items being scheduled to be processed during the execution of the background job.

In another aspect, there is provided a system including: at least one data processor, and at least one memory storing instructions, which when executed by the at least one data processor, cause operations including: identifying a background job type of a background job scheduled to be executed, as a plurality of batches, by a plurality of servers, retrieving background job history data for the background job type, determining using the background job history data corresponding to the background job type, a batch size of the plurality of batches for an execution of the background job, optimizing the batch size of the plurality of batches based on one or more background job characteristics, and controlling an execution of the background job by the plurality of servers.

Implementations may include one or more of the following features. The operations may include: identifying that the background job history data may include a critical background job; and adjusting the batch size based on the critical background job. The operations may include: providing the batch size, to a database, for storage. The one or more background job characteristics may include a maximum duration of the execution of the background job. Determining the batch size of the plurality of batches is based on a set batch size limit and a set number of batches. The background job may include entity identifiers of a set of data items associated to a plurality of entities. The operations may include: generating from the set of data items, a reduced set of data items corresponding to the batch size, the reduced set of data items being scheduled to be processed during the execution of the background job.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that can include one or more processors and one or more memories coupled to the one or more processors. A memory, which can include a non-transitory computer-readable or machine-readable storage medium, can include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to web application user interfaces, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations as provided below.

FIG. 1 illustrates an example operating environment, in accordance with some example implementations;

FIG. 2 depicts an example of an architecture, in accordance with some example implementations;

FIG. 3 depicts a flowchart illustrating an example process, in accordance with some example implementations; and

FIG. 4 depicts a block diagram illustrating a computing system, in accordance with some example implementations.

Where practical, the same or similar reference numbers denote the same or similar or equivalent structures, features, aspects, or elements, in accordance with one or more embodiments.

### DETAILED DESCRIPTION

The disclosed subject matter relates to automated batch sizing for optimizing background jobs based on background job history data. A background job can include the processing of a large data set that might be required to be dynamically divided into multiple batches that are sequentially processed during respective sub-background jobs. Relatively large or complex background job can be triggered to be executed, daily at a particular time, where the underlying data to be processed is divided into multiple batches, where the batches are processed on one or more servers. Depending on implementation, background job history data may be captured over a dedicated course of time or the lifespan of a particular background job type from a particular customer or tenant or customer. The collected background job history data may be in turn utilized for the purpose of simulation, detecting and preventing faults and/or to better understand certain system operations and functionalities by adjusting batch sizing. For example, the background job history data can be used to determine a batch size of the multiple batches selected for execution of the background job. The batch size can be optimized based on one or more background job characteristics. The optimized batch size can be used for execution of the background job, as a series of sub-background jobs, by the multiple servers of the analytic system where each sub-background job executes on one batch. A batch is a group of data items to be processed that is a sub-set of the entire data set where a plurality of batches together is the entire data set to be processed by a background job.

To improve background job processing, computer-implemented systems and methods are provided, in accordance with one or more embodiments, for collecting background job history data classified per background job type and tenant that is then used to dynamically adjust batch size. A background job can include a regularly (daily) scheduled job to process, within a set period of time, a large data set (e.g., daily generated timesheets of all employees of a company). The scope of operation(s) to be performed on the data define the background job type. General examples of background job types include timesheet creation, timesheet editing; timesheet management, importation of data from a third party, timesheet submission, payroll generation, purchase order creation, accounting reconciliation, etc. As these background jobs can be executed multiple times over a given time period, a set of background job history data can be established and later used to dynamically determine a preferred batch size (portion of the data set that can be processed during a sub-background job) wherein the entire background job is divided into multiple batches (forming the entire data set) selected for execution of a scheduled background job of a particular type for a particular tenant or customer. As an advantage of the proposed solution, the automated batch sizing is configured to maintain background job and sub-background job duration below a particular limit. The background job and sub-background job duration can be limited to ensure that a background job of a longer duration does not lead to situations, where the resources of the multithreaded server can be exhausted or heavily taxed. As another advantage, the described process requires lower memory usage and a lower overall central processing unit (CPU) consumption for each background job. The background job servers can process different kinds of background job types in parallel. Analyzing background job duration of a particular background job type for a particular tenant or customer using background job history data can avoid resource exhaustion or delay issues that can then lead to incomplete or delayed background job processing.

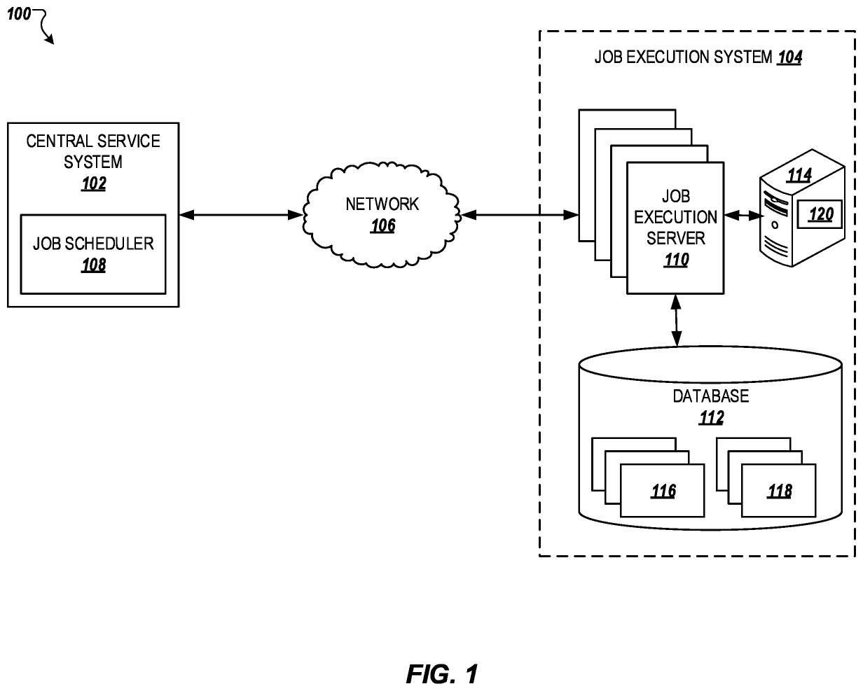

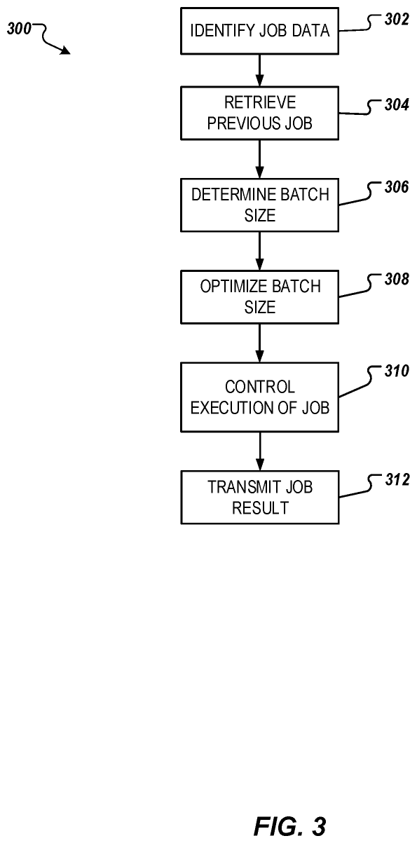

FIG. 1 illustrates an example of a system 100 for automated batch sizing for optimizing scheduling and execution of background jobs based on background job history data, according to some implementations of the current subject matter. The system 100 can be configured to execute one or more processes for optimizing scheduling and execution of background jobs based on background job history data, such as example process 300 described with reference to FIG. 3. The system 100 can include a central service system 102 that can communicate with a background job execution system 104 via a network 106.

The central service system 102 can include a computer system. The central service system 102 can include a general purpose computer, a handheld mobile device, a tablet, or other communication capable device, sensor or monitor. The central service system 102 can include one or more processors and a background job scheduler module 108. The background job scheduler module 108 can include a memory coupled to the one or more processors of the central service system 102 (not shown). The memory of the background job scheduler module 108 can include a non-transitory computer-readable or machine-readable storage medium that can include, encode, store, or the like one or more programs that cause the one or more processors of the central service system 102 to schedule execution of background jobs on the background job execution system 104, as described herein. For example, the background job scheduler module 108 can trigger daily execution of one or more batches of background job(s) and execution of one or more batches, wherein each batch is a sub-set of the entire data set and a sub-background job executes on a single batch. The results of plurality of sub-background jobs executing on each batch taken together form the results of a larger background job. The background job execution system 104 can be configured to identify background jobs that are too small (e.g., below a size threshold) to be divided up into sub-background jobs/batches. Background job scheduler 108 can process background job data received from the background job execution system 104 stored in database 112 to schedule subsequent background job and sub-background job execution. In alternative implementations, database 112 could be shared by central service system 102 and job execution system 104 or be integrated into central service system 102. The integration or segregation of the various components shown in FIG. 1 is not an essential part of the invention unless so claimed.

As shown in FIG. 1, the central service system 102 can be communicatively coupled with the background job execution system 104 to transmit, over the network 106, the background job and sub-background job request data as well as any necessary output data resulting from the execution of the background job. It should be appreciated that the network 106 can be any wired and/or wireless network including, for example, a public land mobile network (PLMN), a local area network (LAN), a wide area network (WAN), the Internet, a cellular network, a telephone network (e.g., PSTN) or an appropriate combination thereof connecting any number of communication devices, mobile computing devices, fixed computing devices, server systems, and/or the like.

The background job execution system 104 includes multiple background job execution servers 110, a database 112 configured to store background job history data 116 and tenant or customer data 118 to be processed during background jobs. Tenant data 118 can be any data that a tenant or customer stores as part of its operations. Examples of tenant data 118 can include employee timesheet data, payroll data, purchase order data, etc. As a further example, tenant data 118 can include large data sets such as employee records for 100,000 employees that require processing by a background job. It should also be noted that different tenants can process the same kinds of data (e.g., timesheet data) but do so in different ways to conform to individual best practices as well as potential regulatory restrictions depending on location. Because of these processing differences across tenants and customers, it is important to track each tenant or customer background job execution history to provide optimal batch sizing for each tenant or customer. Background job execution system 104 also includes computing system 114 configured to optimize execution of the background jobs executed by the background job execution servers 110. In some implementations, the background job execution system 104 and/or any of its components can be incorporated and/or part of a container system that can be used in cloud implementations. The background job execution servers 110 can include any form of servers including, but not limited to a web server (e.g., cloud-based server), an application server, a proxy server, a network server, and/or a server pool. In general, the background job execution servers 110 can accept requests to execute a plurality of background jobs as well as sub-background jobs and generate background job history data 116 that enables background job processing optimization. The background job execution servers 110 can include multiple threads that can process a batch (a portion of a data set) having a particular size that is below a threshold size. The background job execution servers 110 can include a customizing engine, a development system, a test system, and a production system. The background job execution servers 110 can include running instances of corresponding executables (e.g., .exe files) included in the database 112. It should be appreciated that the database 112 can also include other executable (e.g., .exe files) required for running the background job execution system 104. In some implementations, an executable can be a computer program that have already been compiled into machine language and is therefore capable of being executed directly by a data processor.

The database 112 can be any type of database including, for example, an in-memory database, a relational database, a non-SQL (NoSQL) database, and/or the like. As shown in FIG. 1, the database 112 can be a dedicated, single-container database system running a single instance of the background job execution servers 110. However, where the database 112 implements a multitenant database architecture (e.g., multitenant database containers (MDC)), each tenant of the database 112 can be served by separate instances of the background job execution servers 110. In some implementations, the database 112 stores the background job history data 116 received from job execution servicers 110 based on a background job data type and tenant identification data. This data can be part of header information or otherwise indicated by attributes or tags (e.g., data or metadata defining a type, quality, source, or attribute associated with the background job data). The database 112 may transmit the collected background job history data, to the central service system 102. The central service system 102 may include hardware or software implementations (e.g., applications or software objects instantiated over one or more computing systems) that may process background job history data received, to assist job scheduler 108 in scheduling background jobs and sub-background jobs. This can be done either independently by job scheduler 108 or in association with the computing system 114. Depending on the implementation, the collected background job history data may be clustered or categorized into different groups in association with different attributes (e.g., data source, priority, sensitivity, quality, quantity, urgency, context or other factors) that may identify certain background jobs as more important or interesting for the purpose of scheduling background jobs and sub-background jobs, for example. In some implementations, different categories and groups of background job history data may be collected, identified, stored or streamed as belonging to different background job types and tenants or customers.

The computing system 114 and/or servers 110 can be and/or include any type of processor and memory based device, such as a general purpose computer, a handheld mobile device, a tablet, or other communication capable device, sensor or monitor. The computing system 114 can include a batch size determiner 120. The batch size determiner 120 can include a software or hardware implemented device configured to analyze background job history data 116 to optimize execution of background jobs by the background job execution servers 110. The batch size determiner 120 can include a dedicated application or other type of software application, in communication with, or running either fully or partially on the computing system 114. It is noteworthy that the computing system 114 and other software or hardware elements of the background job execution system 104 associated with optimizing execution of background jobs may be implemented over a centralized or distributed (e.g., cloud-based) computing environment as dedicated resources or may be configured as virtual machines that define shared processing or storage resources.

By way of example, a relatively larger tenant or customer data sets 118 or more complex background jobs can be divided into a set of sub-background jobs each with an associated batch of data. In this manner, computing resources can be more efficiently shared among a plurality of background jobs and a plurality of tenants or customers. In one example, a particularly large or complex background job from one tenant or customer is divided into smaller sub-background jobs whose individual execution by job execution servers 110 will not be overwhelming and thus blocking or delaying the execution of other background jobs from the same or different tenant or customer.

An optimized background job execution can include a series of sub-background computing processes (e.g., batch processes) to enable entire processing of a data set divided into batches. A batch process associated with a target set of data, or an identified stream of data, may be utilized to process the data according to particular defined rules and optimization parameters, over a certain period of time. One or more batch processes associated with a particular stream or group of data may be scheduled by the background job scheduler 108 to be executed at a particular time, by the background job execution servers 110. In one aspect, available resources (a portion of the background job execution servers 110) may be allocated to all or selected batch processes invoked by a triggering background job.

The above methodology provides for a timely invocation of one or more batch processes with a focus on a data set or series of background jobs, and desirably based on rules that define background job execution processes. Such approach provides for the capability to timely and efficiently execute background jobs associated with large volumes of collected background job data, without exhausting the processing resources of the background job execution system 104. The proposed implementations discussed above and as illustrated in the accompanying figures overcome the deficiencies associated with the traditional systems by optimizing background job execution using adjustable batch sizes.

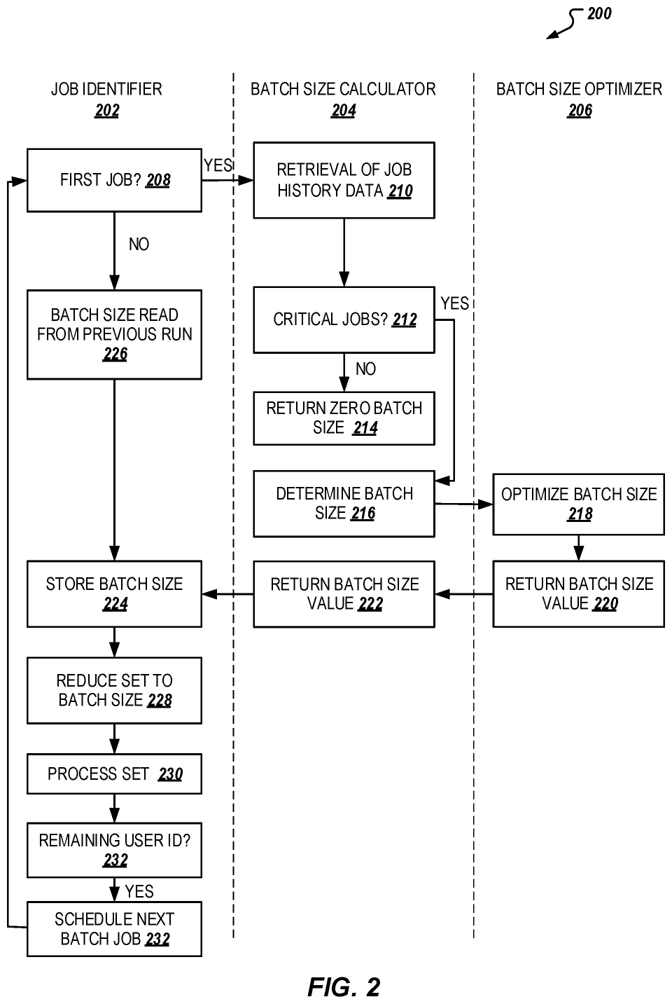

FIG. 2 illustrates an example of an architecture 200 for automated batch sizing. The example of the architecture 200 can be implemented as batch size determiner 120. In alternative implementations, architecture 200 can be segregated or integrated into any of the other components or any combination of components of the example system 100 described with reference to FIG. 1. The example of the architecture 200 includes a background job identifier 202, a batch size calculator 204, and a batch size optimizer 206.

The background job identifier 202 can perform identification of a background job 203. The identification of the background job includes identifying if the background job has sufficient historical data to implement dynamic batch sizing if necessary. If there is insufficient historical data (e.g., collected over less than 3 weeks), execution of the background job by job execution server 110 is triggered and the associated data such as background job type and tenant ID is saved 205.

If there is sufficient historical data, then a determination is made if the present background job is an initial background job after sufficient historical data has been collected (e.g., the first background job of a particular type and tenant after 3 previous weeks of execution of the same background job of the particular type and tenant) 208. An initial background job is the first background job with a particular type and tenant in which sufficient historical data for that job type and tenant has been collected. It includes executing the first background job for a newer tenant of customer (e.g. a tenant who began using the software 3 weeks ago), executing a background job where either the software or rules have been updated recently (e.g., 3 weeks ago such as a software update from version 1.0 to 1.1 or a change in rules or data such as an update in a legal or logistical requirement) or a substantial change in the size of the data set (e.g., a merger of two companies of 50,000 employees each creates a new dataset of 100,000 employees) after sufficient historical data has been collected.

The batch size calculator 204 can be configured to receive the identification of the background job scheduled to be executed, from the background job identifier 202. The batch size calculator 204 can read the background job type and tenant of the present background job and use this information to retrieve background job history data 116 from database 112 210. The batch size calculator 204 can read the background job history data 210 corresponding to a past period of time (e.g., last 21 days) using the identification of the background job type and tenant.

The batch size calculator 204 can identify critical background jobs 212 from the background job history data. The batch size calculator 204 can use the identified critical background jobs for auto batching of scheduled background jobs. By using auto batching, the batch size calculator 204 can mitigate issues caused by repeatedly long running background jobs for one customer and a particular background job type. A critical background job is one a) whose execution uses too many resources (e.g., CPU time) and thus can block other background jobs from executing or takes too long (e.g., over 2 hours) that it again blocks other background jobs from executing or itself is so long in execution that an error is generated and the background job stops executing or generates faulty results and b) is scheduled with some regularity over a certain period of time (e.g. a repeating scheme).

The batch size calculator 204 can use any number of methods two ways to identify a repeating scheme. One such method is by averaging duration. In this method, the actual duration to execute the background job is averaged over a historical period, say 21 days. However, this method can mask a critical job that is executed relatively infrequently (e.g., once per week vs. once per day). As an example, suppose a background job needs 8 hours to execute but is only scheduled to execute on Mondays (i.e., 3 times in a 21 day period), the daily average would be (8 hours*3 times)/21 days or approximately 1.14 hours per day. If the threshold is set at 2 hours per day, this background job type of this particular tenant would not be designated as critical, but in fact it would cause significant issues every Monday. It should be noted that these background jobs could be identified as critical jobs if the threshold were reduced, say to 1 hour.

A second method to identify a repeating scheme is by identifying a maximum duration per week across a particular time frame (e.g., three weeks). In this method, the batch size calculator 204 can divide a time frame (e.g., a time frame of 21 days) into multiple segments (e.g., three seven day segments) and identify the longest running background jobs within each segment. If the long running background jobs exceed a threshold in multiple consecutive segments (e.g., three consecutive weeks), the background job is identified as being critical and the durations for each of those background jobs can be averaged together for batch calculation. Those background jobs that are below the established threshold are not identified as critical jobs. It should be noted that the longest running background jobs within each segment can also be used to identify a peak time within each segment (e.g., peak day in a week).

It should be noted that a batch can be processed faster than the entire data set from which it came. Thus, utilizing the teachings of this invention can mask a large background job because each individual batch will be below the threshold. To correct this, the batch size calculator 204 can use an algorithm that normalizes past background job durations by using a correction factor. The correction factor can be equal to the background job batch size divided by the overall number of data items (user identifiers) to be processed. The normalized duration is calculated as the background job run duration divided by the correction factor. As an example, if a data set of a background job is divided into 10 batches of equal size, the correction factor would be 1/10. If each batch has a processing duration time of 1 hour, below the 2 hour threshold, it would appear that these batches are not critical jobs and thus subsequent executions of this background job would not be batched. By dividing by the correction factor, the calculated duration time is 20 hours and thus above the threshold. The normalized duration is considered to identify critical background jobs.

If no critical background jobs are identified, a zero batch size (e.g., no batching is needed as the background job can execute under the threshold as is) is determined 214. If critical background jobs are identified, the batch size is determined 215. The batch size can include a number (e.g., 99) of sub-background jobs or batches derived from the background job that can be scheduled for subsequent execution for a particular background job type for a particular customer instance that are estimated to be executed during a particular processing duration.

Before sending the batch size to the batch size optimizer 206, the batch size calculator 204 can obtain boundary conditions 216. One such boundary, for example, can limit a maximum number (e.g., 99) of sub-background jobs or batches derived from the background job to be scheduled for subsequent execution for a particular background job type for a particular customer instance. The maximum number of schedulable jobs per job type per tenant can define the technical lower limit of a batch size of a sub-background job (e.g., for 100,000 data items in one background job, the batch size cannot be below, 1,011 data items (100,000/99)) expected to be executed during a particular processing duration. A second boundary may be set by a database query limit to limit the upper level of the batch size. A query to retrieve the data items from the database can include (in the where clause) the user/data identifiers. In some implementations, a limit of the set size can include tens of thousands of identifiers (e.g., 30,000 user/data identifiers). Combing these two boundaries together, the target batch size, for this example, should be between 1,011 and 30,000 data items.

A third possible boundary is the execution of a background job can be set to finish within a given limit, e.g., 10 hours. In other words, all batch process derived from a single background job must complete execution within this 10 hour window. If an administrator attempts to input into the algorithm average duration exceeding the set limit, the batch size calculator 204 can generate an alert and deny the execution of the background job. Other boundaries and values for such boundaries are contemplated in this invention and the above examples are not limiting on the scope of the invention. The batch size calculator 204 determines input data for the batch size optimizer 206 (historic job execution data, technical boundary conditions and maximum execution duration limit per batch as input by an administrator). The batch size calculator 204 transmits the input data to the batch size optimizer 206.

The batch size optimizer 206 can calculate the optimal batch size 218 using an algorithm based on the following formula that rounds the product of the division between the overall item numbers and the average duration (hours times hour limit), e.g.:

Math.round(overallItemNumber/avgDurationHours*avgDurationHoursLimit).

As an example, if there are 100,000 data items to be processed in a background job and the average duration of three executions over a 21-day period was 4.2 hours and the system administrator wants the average duration of all background jobs to be 1.5 hours, the result is a batch size of 35,714. Since the batch exceeds the boundary condition of 30,000 data items, the batch size is reduced to 30,000 data items in 3 batches and the remaining 10,000 in a 4th batch. The batch size optimization (reduction) meets the boundary conditions of not having more than 99 batches where each batch is below 30,000 data items. The batch size optimizer 206 can consider other boundary conditions (related to server and business characteristics) and can adjust the optimal batch size, if needed. The batch size optimizer 206 can transmit the optimal batch size value 220 to the batch size calculator 204. The batch size calculator 204 can transmit the optimal batch size value 222 to the background job executor 202 to store it in the database 224 to enable direct retrieval for subsequent sub-background jobs.

The background job identifier 202 can compare the item data set to the batch size. If the item data set is greater than the optimized batch size, the background job identifier 202 can use the batch size to reduce the item data set 228 by dividing it into a plurality of batches for sub-background job processing. The background job identifier 202 can trigger the execution of the first sub-background job by transmitting the first batch data set to the job execution servers 110 for processing 230. For example, the background job executor 202 can transmit the first batch of data items to the job execution servers 110 to execute in a first run and can transmit, to the job execution servers 110, the remaining batches when a subsequent sub-background job is scheduled to be executed by job scheduler 108. The background job identifier 202 can receive, from the job execution servers 110, data indicating that the processing of the previously sent batch is completed. After each batch is processed, it is determined whether remaining batches of data have yet to be processed 232, which would require an additional batch job. If remaining batches of data exist, a next batch sub-background job is scheduled 234 by job scheduler 108 with the remaining batches. The background job identifier 202 can schedule the subsequent sub-background job even if a current sub-background job failed with an exception. The described example architecture 200 enables scheduling of controlled cycles of background job execution with an optimal batch size to avoid exhaustion of processing resources.

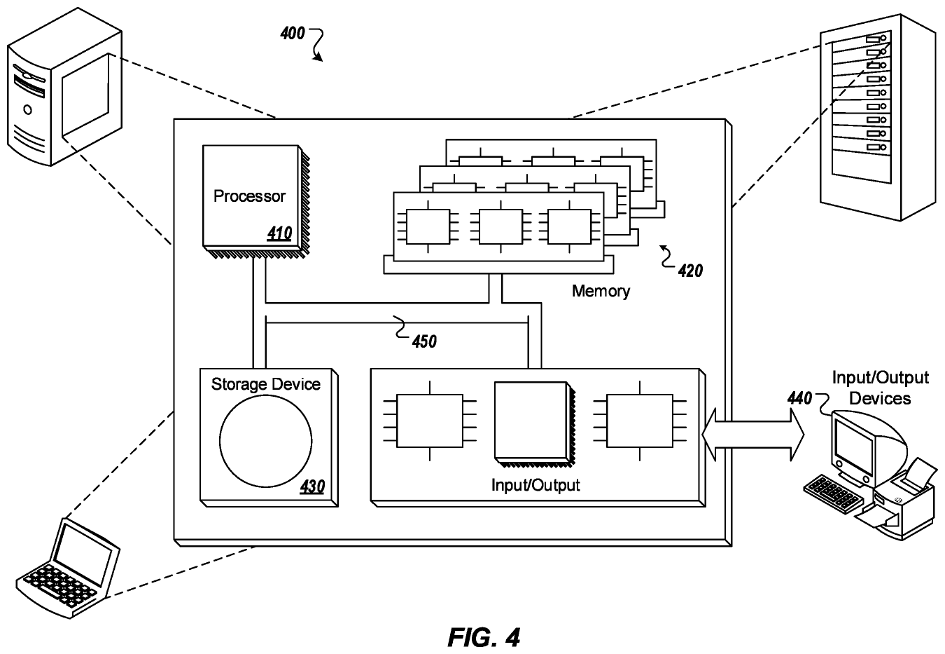

FIG. 3 depicts a flowchart illustrating a process 300 for optimizing batch sizes for background job execution, in accordance with some example implementations. The process 300 can be executed by the system 100 shown in FIG. 1, using the example architecture 200 shown in FIG. 2, the system 400 shown in FIG. 4 or any combination thereof.

At 302, a background job of a particular type for a particular tenant or customer is scheduled to be executed. The background job can include processing of an item data set including multiple (e.g., thousands of) items (e.g., timesheets, log entries, or any type of multidimensional data, such as tables) that can be generated at a set frequency (e.g., on a daily basis) by an entity (e.g., customer) identifiable using an entity identifier. In some implementations, each item includes a user identifier (e.g., employer number associated with the customer) and one or more variable parameters (e.g., number of hours worked on one of multiple projects). In some instances, the number of items in the item data set is approximately constant (having a variance of less than a particular percentage, such as 5%) over a period of time. The background job can correspond to a background job type that defines a processing type corresponding to the type of data as well as the operations to be performed on that data.

At 304, background job history data for the background job type and tenant is retrieved from a database. For example, the background job history data corresponding to a past period of time (e.g., last 21 days) can be retrieved using the background job type tenant as the identification of the background job. The background job history data can include information about past background jobs, including past background job durations, batch sizes, and size of item data set (e.g., number of items in the item data set). The background job history data can be processed to normalize past background job durations by using a correction factor. The correction factor can be equal to the background job batch size divided by the overall number of item data in the set to be processed. The normalized duration is calculated as the background job run duration divided by the correction factor. The normalized duration is considered to identify critical background jobs. The critical background jobs include past background jobs that exceeded a set threshold of a duration of background job execution.

At 306, a batch size defining a number of items from the item data set that can be transmitted to the servers as a batch for execution is determined. The batch size can be determined by averaging the normalized durations of the longest running past background jobs within each of the time segments. The averaging result can define an average maximum duration that corresponds to a batch size that is predicted to be processed within the average maximum duration based on the past durations of background job executions.

At 307, boundary conditions associated to the batch size can be determined. The boundary conditions can be determined based on processing system parameters and other parameters defining an execution deadline or duration. For example, boundary conditions can define the size of the item data set to ensure that the background job satisfies the technical boundaries imposed by the usage conditions of the servers. For example, the server usage can allow a maximum number (e.g., 99) of sub-background jobs of the background job to be scheduled for subsequent execution during one background job of a particular background job type for a particular customer instance. The maximum number of data items can define the technical lower limit of a batch size of a sub-background job. The scheduling of a follow-up of a sub-background job can require a number of user identifiers to be set. The number of user identifiers can define an upper limit for the number of data item. A query to retrieve the data items from the database can include (in the where clause) the user identifiers. In some implementations, boundary conditions can define a limit of the batch size to include a maximum batch size (e.g., tens of thousands of item data) with respective identifiers (e.g., 30,000 user identifiers). The boundary conditions can define a particular time limit (e.g., 10 hours) for an execution of daily background jobs including all sub-background jobs of the background job.

At 308, the batch size is optimized. The batch size can be optimized by using an algorithm based on the following formula that rounds the product of the division between the overall number of data item and the average duration (hours times hour limit) of past background jobs identified in the background job history data:

OptimizedBatchSize=Math.round(overallItemNumber/avgDurationHours*avgDurationHoursLimit).

The batch size can be optimized by considering various boundary conditions (related to server characteristics) and can adjust the optimal batch size, if needed. In some implementations, the batch size can be optimized by decreasing a preset percentage (e.g., by a quarter) to avoid critical background jobs and/or reaching server processing limits. In some implementations, the batch size patterns are being analyzed relative to the server characteristics using a model. The model can include one or more machine learning models trainable to generate the optimized batch size. The one or more machine learning models can be trained, recalibrated, and updated to generate optimized batch size with increased accuracy even for servers with variable components. The optimized batch size can be used to automatically prevent critical background jobs, while critical background jobs are used for retraining the model. The provided solution can include a machine learning model that can be applied to most types of server configurations, computing device configurations and software product configurations, replacing the current optimization formula.

At 310, the execution of the background job is controlled by using a schedule that defines an order of the sub-background jobs that can be subsequently executed by the servers to complete the background job within a set period of time (e.g., 10 hours). For example, the set of data items to be processed during the background job are divided based on the optimized batch size to generate the sub-background jobs, as a reduced set of data items, which can be ordered according to a data retrieval criteria (e.g., user identifiers). In some implementations, the schedule for the execution of the background job can be adjusted relative to one or more additional background jobs that are scheduled to be executed by the servers.

At 312, a background job result including the data processing results is transmitted to the database for storage to be added to the background job history data. The background job results, including background job duration, processing results, and item data set, can be used to enable subsequent optimization of the batch sizing.

In some implementations, the current subject matter can be configured to be implemented in a system 400, as shown in FIG. 4. The system 400 can include a processor 410, a memory 420, a storage device 430, and an input/output device 440. Each of the components 410, 420, 430 and 440 can be interconnected using a system bus 450. The processor 410 can be configured to process instructions for execution within the system 400. In some implementations, the processor 410 can be a single-threaded processor. In alternate implementations, the processor 410 can be a multi-threaded processor. The processor 410 can be further configured to process instructions stored in the memory 420 or on the storage device 430, including receiving or sending information through the input/output device 440. The memory 420 can store information within the system 400. In some implementations, the memory 420 can be a computer-readable medium. In alternate implementations, the memory 420 can be a volatile memory unit. In yet some implementations, the memory 420 can be a non-volatile memory unit. The storage device 430 can be capable of providing mass storage for the system 400. In some implementations, the storage device 430 can be a computer-readable medium. In alternate implementations, the storage device 430 can be a floppy disk device, a hard disk device, an optical disk device, a tape device, non-volatile solid state memory, or any other type of storage device. The input/output device 440 can be configured to provide input/output operations for the system 400. In some implementations, the input/output device 440 can include a keyboard and/or pointing device. In alternate implementations, the input/output device 440 can include a display unit for displaying graphical user interfaces.

In some implementations, one or more application function libraries in the plurality of application function libraries can be stored in the one or more tables as binary large objects. Further, a structured query language can be used to query the storage location storing the application function library.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first background job from a second background job, but need not imply any chronological ordering or a fixed reference system (such that a first background job in one paragraph of the description can be different from a first background job in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more user device computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include user devices and servers. A user device and server are generally, but not exclusively, remote from each other and typically interact through a communication network. The relationship of user device and server arises by virtue of computer programs running on the respective computers and having a user device-server relationship to each other.

Further non-limiting aspects or embodiments are set forth in the following numbered examples:

Example 1: A computer-implemented method comprising: identifying, by one or more processors, a background job type of a background job scheduled to be executed, as a plurality of batches, by a plurality of servers, retrieving, by the one or more processors, background job history data for the background job type, determining, by the one or more processors, using the background job history data corresponding to the background job type, a batch size of the plurality of batches for an execution of the background job, optimizing, by the one or more processors, the batch size of the plurality of batches based on one or more background job characteristics, and controlling, by the one or more processors, an execution of the background job by the plurality of servers.

Example 2: The computer-implemented method of example 1, further comprising: identifying, by the one or more processors, that the background job history data comprises a critical background job, and adjusting, by the one or more processors, the batch size based on the critical background job.

Example 3: The computer-implemented method of example 1 or 2, further comprising: providing, by the one or more processors, the batch size, to a database, for storage.

Example 4: The computer-implemented method of any one of preceding examples, wherein the one or more background job characteristics comprise a maximum duration of the execution of the background job.

Example 5: The computer-implemented method of any one of preceding examples, wherein determining, by the one or more processors, the batch size of the plurality of batches is based on a set batch size limit and a set number of batches.

Example 6: The computer-implemented method of any one of preceding examples, wherein the background job comprises entity identifiers of a set of data items associated to a plurality of entities.

Example 7: The computer-implemented method of any one of preceding examples, further comprising: generating, by the one or more processors, from the set of data items, a reduced set of data items corresponding to the batch size, the reduced set of data items being scheduled to be processed during the execution of the background job.

Example 8: A non-transitory computer-readable storage medium comprising programming code, which when executed by at least one data processor, causes operations comprising: identifying a background job type of a background job scheduled to be executed, as a plurality of batches, by a plurality of servers, retrieving background job history data for the background job type, determining using the background job history data corresponding to the background job type, a batch size of the plurality of batches for an execution of the background job, optimizing the batch size of the plurality of batches based on one or more background job characteristics, and controlling an execution of the background job by the plurality of servers.

Example 9: The non-transitory computer-readable storage medium of example 8, wherein the operations further comprise: identifying that the background job history data comprises a critical background job, and adjusting the batch size based on the critical background job.

Example 10: The non-transitory computer-readable storage medium of example 8 or 9, wherein the operations further comprise: providing the batch size, to a database, for storage.

Example 11: The non-transitory computer-readable storage medium of any one of examples 8 to 10, wherein the one or more background job characteristics comprise a maximum duration of the execution of the background job.

Example 12: The non-transitory computer-readable storage medium of any one of examples 8 to 10, wherein determining the batch size of the plurality of batches is based on a set batch size limit and a set number of batches.

Example 13: The non-transitory computer-readable storage medium of any one of examples 8 to 12, wherein the background job comprises entity identifiers of a set of data items associated to a plurality of entities.

Example 14: The non-transitory computer-readable storage medium of any one of examples 8 to 13, wherein the operations further comprise: generating from the set of data items, a reduced set of data items corresponding to the batch size, the reduced set of data items being scheduled to be processed during the execution of the background job.

Example 15: A system comprising: at least one data processor, and at least one memory storing instructions, which when executed by the at least one data processor, cause operations comprising: identifying a background job type of a background job scheduled to be executed, as a plurality of batches, by a plurality of servers, retrieving background job history data for the background job type, determining using the background job history data corresponding to the background job type, a batch size of the plurality of batches for an execution of the background job, optimizing the batch size of the plurality of batches based on one or more background job characteristics, and controlling an execution of the background job by the plurality of servers.

Example 16: The system of example 15, wherein the operations further comprise: identifying that the background job history data comprises a critical background job, and adjusting the batch size based on the critical background job.

Example 17: The system of example 15 or 16, wherein the operations further comprise: providing the batch size, to a database, for storage.

Example 18: The system of any one of examples 15 to 17, wherein the one or more background job characteristics comprise a maximum duration of the execution of the background job.

Example 19: The system of any one of examples 15 to 18, wherein determining the batch size of the plurality of batches is based on a set batch size limit and a set number of batches.

Example 20: The system of any one of examples 15 to 19, wherein the background job comprises entity identifiers of a set of data items associated to a plurality of entities and wherein the operations further comprise: generating from the set of data items, a reduced set of data items corresponding to the batch size, the reduced set of data items being scheduled to be processed during the execution of the background job.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed is:

1. A computer-implemented method comprising:
identifying, by one or more processors, a background job type of a background job scheduled to be executed, as a plurality of batches;
retrieving, by the one or more processors, background job history data for the background job type;
determining, by the one or more processors, using the background job history data corresponding to the background job type, a batch size of the plurality of batches for an execution of the background job;
optimizing, by the one or more processors, the batch size of the plurality of batches based on one or more background job thresholds and the background job history;
grouping subsets of a data set associated with the background job into the plurality of batches; and
controlling, by the one or more processors, an execution of the background job by executing a plurality of sub-background jobs wherein each sub-background job is associated with one batch from the plurality of batches.

2. The computer-implemented method of claim 1, further comprising:
identifying, by the one or more processors, that the background job history data comprises a critical background job

3. The computer-implemented method of claim 1, further comprising:
providing, by the one or more processors, the batch size, to a database, for storage.

4. The computer-implemented method of claim 1, wherein the one or more background job thresholds comprise a maximum duration of the execution of the background job.

5. The computer-implemented method of claim 1, wherein determining, by the one or more processors, the batch size of the plurality of batches is based on a set batch size limit and a set number of batches.

6. The computer-implemented method of claim 1, wherein the background job comprises entity identifiers of a set of data items associated to a plurality of entities.

7. The computer-implemented method of claim 1, further comprising:
identifying a tenant associated with the background job, wherein the background job history is associated with the tenant.

8. A non-transitory computer-readable storage medium comprising programming code, which when executed by at least one data processor, causes operations comprising:
identifying, by one or more processors, a background job type of a background job scheduled to be executed, as a plurality of batches;
retrieving, by the one or more processors, background job history data for the background job type;
determining, by the one or more processors, using the background job history data corresponding to the background job type, a batch size of the plurality of batches for an execution of the background job;
optimizing, by the one or more processors, the batch size of the plurality of batches based on one or more background job thresholds and the background job history;
grouping subsets of a data set associated with the background job into the plurality of batches; and
controlling, by the one or more processors, an execution of the background job by executing a plurality of sub-background jobs wherein each sub-background job is associated with one batch from the plurality of batches.

9. The non-transitory computer-readable storage medium of claim 8, wherein the operations further comprise:
identifying that the background job history data comprises a critical background job.

10. The non-transitory computer-readable storage medium of claim 8, wherein the operations further comprise:
providing the batch size, to a database, for storage.

11. The non-transitory computer-readable storage medium of claim 8, wherein the one or more background job thresholds comprise a maximum duration of the execution of the background job.

12. The non-transitory computer-readable storage medium of claim 8, wherein determining the batch size of the plurality of batches is based on a set batch size limit and a set number of batches.

13. The non-transitory computer-readable storage medium of claim 8, wherein the background job comprises entity identifiers of a set of data items associated to a plurality of entities.

14. The non-transitory computer-readable storage medium of claim 13, wherein the operations further comprise:
identifying a tenant associated with the background job, wherein the background job history is associated with the tenant.

15. A system comprising:
at least one data processor; and
at least one memory storing instructions, which when executed by the at least one data processor, cause operations comprising:
identifying, by one or more processors, a background job type of a background job scheduled to be executed, as a plurality of batches;
retrieving, by the one or more processors, background job history data for the background job type;
determining, by the one or more processors, using the background job history data corresponding to the background job type, a batch size of the plurality of batches for an execution of the background job;
optimizing, by the one or more processors, the batch size of the plurality of batches based on one or more background job thresholds and the background job history;
grouping subsets of a data set associated with the background job into the plurality of batches; and
controlling, by the one or more processors, an execution of the background job by executing a plurality of sub-background jobs wherein each sub-background job is associated with one batch from the plurality of batches.

16. The system of claim 15, wherein the operations further comprise:
identifying that the background job history data comprises a critical background job.

17. The system of claim 15, wherein the operations further comprise:
providing the batch size, to a database, for storage.

18. The system of claim 15, wherein the one or more background job thresholds comprise a maximum duration of the execution of the background job.

19. The system of claim 15, wherein determining the batch size of the plurality of batches is based on a set batch size limit and a set number of batches.

20. The system of claim 15, wherein the background job comprises entity identifiers of a set of data items associated to a plurality of entities and wherein the operations further comprise:
identifying a tenant associated with the background job, wherein the background job history is associated with the tenant.
